(19) United States
(12) Patent Application Publication
(10) Pub. No.: US 2024/0062730 A1
(43) Pub. Date: Feb. 22, 2024

(54) BACKLIGHT MODULE AND DISPLAY DEVICE

(71) Applicant: WUHAN CHINA STAR OPTOELECTRONICS TECHNOLOGY CO., LTD., Wuhan (CN)

(72) Inventor: Peng Tu, Wuhan (CN)

(73) Assignee: WUHAN CHINA STAR OPTOELECTRONICS TECHNOLOGY CO., LTD., Wuhan (CN)

(21) Appl. No.: 17/607,361

(22) PCT Filed: Sep. 6, 2021
(86) PCT No.: PCT/CN2021/116600

§ 371 Date: Feb. 23, 2023

(30) Foreign Application Priority Data
Aug. 19, 2021 (CN) 202110955195.5

(51) Int. Cl. G09G 3/34; G09G 3/32

(52) U.S. Cl. CPC G09G 3/3426; G09G 3/32

(57) ABSTRACT

Disclosed are a backlight module and a display panel. The backlight module has a plurality of light-emitting unit groups. Each of the light-emitting unit groups has a plurality of light-emitting units. The plurality of light-emitting units are arranged in an array.

### FIELD OF THE INVENTION

The present application relates to a display technology field, and more particularly to a backlight module and a display device.

### BACKGROUND OF THE INVENTION

The miniLED direct backlight is a new technology to enhance the display effect of the display panel. The miniLED driving way has also developed a variety of technologies, and the determinant driving way is one of the more excellent driving ways. In the general scheme of miniLED determinant driving, the drive circuit of miniLEDs arranged in M rows and N columns also needs M row light-emitting control units and N column light-emitting control units.

However, for the miniLED determinant driving, the required number of column light-emitting control units is too large for products with an excessively large column/row ratio; for products with an excessively large row/column ratio, the required number of the row light-emitting control units is too large.

### SUMMARY OF THE INVENTION

The present application provides a backlight module and a display device, which can reuse column light-emitting control units or row light-emitting control units according to product requirements, so that the number of column light-emitting control units or row light-emitting control units can be reduced.

First, the present application provides a backlight module, comprising:

a light-emitting array comprising a plurality of light-emitting unit groups, each of the light-emitting unit groups comprises a plurality of light-emitting units, and the plurality of light-emitting units are arranged in an array;

a plurality of first light-emitting control units, and the plurality of first light-emitting control units correspond to the plurality of light-emitting unit groups one-to-one, and a first end of each first light-emitting control unit is electrically connected to a first voltage line, and a second end of each first light-emitting control unit is connected to a first end of each light-emitting unit in the corresponding light-emitting unit group; and

a plurality of second light-emitting control units, and the plurality of second light-emitting control units correspond to the plurality of light-emitting unit groups one-to-one, and a first end of each second light-emitting control unit is electrically connected to a second voltage line, and a second end of each second light-emitting control unit is electrically connected to a second end of the corresponding light-emitting unit.

In the backlight module provided by the present application, one column of the light-emitting units corresponds to one column line, and the first ends of all the light-emitting units in the same column is electrically connected to the same column line; the column lines corresponding to the same light-emitting unit group are electrically connected to the second end of the first light-emitting control unit corresponding thereto.

In the backlight module provided by the present application, the backlight module comprises a first side, and the plurality of first light-emitting control units and the first voltage line are located on the first side.

In the backlight module provided by the present application, the first light-emitting control unit comprises a first switching element and a constant current subunit, and the first switching element is arranged in series with the constant current subunit.

In the backlight module provided by the present application, one row of the light-emitting units corresponds to a plurality of row lines, and the plurality of row lines corresponds to the plurality of columns of the light-emitting units in the light-emitting unit group one-to-one; each light-emitting unit in the light-emitting unit group is correspondingly electrically connected to one of the row lines, and each of the row lines is correspondingly electrically connected to the second end of the corresponding second light-emitting control unit.

In the backlight module provided by the present application, the light-emitting units in the different light-emitting unit groups correspond one-to-one, and the corresponding light-emitting units in the different light-emitting unit groups are electrically connected to the same row line.

In the backlight module provided by the present application, the backlight module comprises a second side, and the plurality of second light-emitting control units and the second voltage line are located on the second side.

In the backlight module provided by the present application, the backlight module further comprises a third side and a fourth side which are arranged oppositely, and the third side and the fourth side are arranged with the second light-emitting control unit and the second voltage line.

In the backlight module provided by the present application, the plurality of row lines corresponding to all rows of the light-emitting units are arranged at intervals along a column direction.

In the backlight module provided by the present application, the plurality of row lines corresponding to all row of the light-emitting units are arranged at intervals along a row direction.

In the backlight module provided by the present application, one row of the light-emitting units corresponds to one row line, and the first ends of all the light-emitting units in the same row are electrically connected to the same row line; the row lines corresponding to the same light-emitting unit group are electrically connected to the second end of the corresponding first light-emitting control unit.

In the backlight module provided by the present application, one column of the light-emitting units corresponds to a plurality of column lines, and the plurality of column lines corresponds to the plurality of rows of the light-emitting units in the light-emitting unit group one-to-one; each of the light-emitting units in the light-emitting unit group is correspondingly electrically connected to one of the column lines, and each of the column lines is correspondingly electrically connected to the second end of the second light-emitting control unit corresponding thereto.

In the backlight module provided by the present application, the light-emitting units in the different light-emitting unit groups correspond one-to-one, and the corresponding light-emitting units in the different light-emitting unit groups are electrically connected to the same column line.

In the backlight module provided by the present application, the plurality of column lines corresponding to all columns of the light-emitting units are arranged at intervals along a column direction.

In the backlight module provided by the present application, the plurality of column lines corresponding to all columns of the light-emitting units are arranged at intervals along a row direction.

Second, the present application further provides a display device, comprising a backlight module and a display panel, and the display panel is arranged on the backlight module;

the backlight module comprises:

a light-emitting array comprising a plurality of light-emitting unit groups, each of the light-emitting unit groups comprises a plurality of light-emitting units, and the plurality of light-emitting units are arranged in an array;

a plurality of first light-emitting control units, and the plurality of first light-emitting control units correspond to the plurality of light-emitting unit groups one-to-one, and a first end of each first light-emitting control unit is electrically connected to a first voltage line, and a second end of each first light-emitting control unit is connected to a first end of each light-emitting unit in the corresponding light-emitting unit group; and

a plurality of second light-emitting control units, and the plurality of second light-emitting control units correspond to the plurality of light-emitting unit groups one-to-one, and a first end of each second light-emitting control unit is electrically connected to a second voltage line, and a second end of each second light-emitting control unit is electrically connected to a second end of the corresponding light-emitting unit.

In the display device provided by the present application, one column of the light-emitting units corresponds to one column line, and the first ends of all the light-emitting units in the same column is electrically connected to the same column line; the column lines corresponding to the same light-emitting unit group are electrically connected to the second end of the first light-emitting control unit corresponding thereto.

In the display device provided by the present application, the backlight module comprises a first side, and the plurality of first light-emitting control units and the first voltage line are located on the first side.

In the display device provided by the present application, the first light-emitting control unit comprises a first switching element and a constant current subunit, and the first switching element is arranged in series with the constant current subunit.

In the display device provided by the present application, one row of the light-emitting units corresponds to a plurality of row lines, and the plurality of row lines corresponds to the plurality of columns of the light-emitting units in the light-emitting unit group one-to-one; each light-emitting unit in the light-emitting unit group is correspondingly electrically connected to one of the row lines, and each of the row lines is correspondingly electrically connected to the second end of the corresponding second light-emitting control unit.

In backlight module and display device provided by the present application, the plurality of first light-emitting control units are correspond to the plurality of light-emitting units one-to-one, and the plurality of second light-emitting control units correspond to the plurality of light-emitting units in the light-emitting unit group one-to-one. Therefore, the first light-emitting control unit can be multiplexed, thereby reducing the number of the first light-emitting control units; namely, column light-emitting control units or row light-emitting control units can be multiplexed according to product requirements, so that the number of column light-emitting control units or row light-emitting control units can be reduced.

### BRIEF DESCRIPTION OF THE DRAWINGS

In order to more clearly illustrate the embodiments of the present application, the following figures will be described in the embodiments are briefly introduced. It is obvious that the drawings are only some embodiments of the present application, those of ordinary skill in this field can obtain other figures according to these figures without paying the premise.

FIG. 1 is a schematic diagram of a first structure of a backlight module provided by an embodiment of the present application;

FIG. 2 is a schematic diagram of a second structure of a backlight module provided by an embodiment of the present application;

FIG. 3 is a schematic diagram of a third structure of a backlight module provided by an embodiment of the present application;

FIG. 4 is a schematic diagram of a fourth structure of a backlight module provided by an embodiment of the present application;

FIG. 5 is a schematic diagram of a fifth structure of a backlight module provided by an embodiment of the present application.

### DETAILED DESCRIPTION OF PREFERRED EMBODIMENTS

For better explaining the technical solution and the effect of the present invention, the present invention will be further described in detail with the accompanying drawings in the specific embodiments. It is clear that the described embodiments are merely part of embodiments of the present application, but not all embodiments. Based on the embodiments of the present application, all other embodiments to those of skilled in the premise of no creative efforts obtained, should be considered within the scope of protection of the present application. It should be understood that the specific embodiments described herein are merely for illustrating and explaining the present application and are not intended to limit the present application. Besides, the terminologies “first”, “second”, “third” and “fourth” in the claims and specification of the present application are used for distinguishing different objects but not for describing the specific sequence.

The embodiment of the present application provides a backlight module, which will be described in detail below. It should be noted that the order of description in the following embodiments is not meant to limit the preferred order of the embodiments.

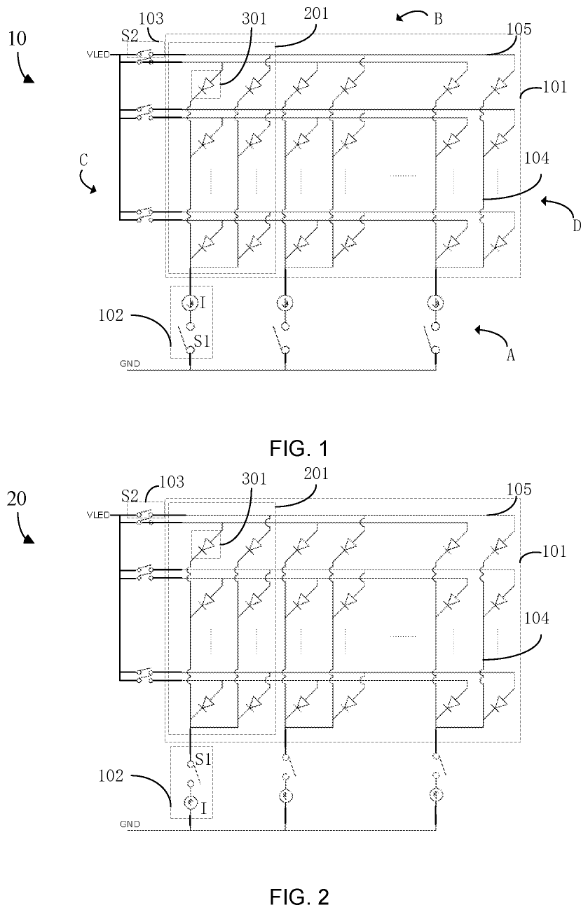

Please refer to FIG. 1. FIG. 1 is a schematic diagram of a first structure of a backlight module provided by an embodiment of the present application. As shown in FIG. 1, the backlight module 10 provided by the embodiment of the present application comprises a light-emitting array 101, a plurality of first light-emitting control units 102 and a plurality of second light-emitting control units 103. The light-emitting array 101 comprises a plurality of light-emitting unit groups 201. Each of the light-emitting unit groups 201 has a plurality of light-emitting units 301. The plurality of light-emitting units 301 are arranged in an array. Each first light-emitting control unit 102 has a first end and a second end, each second light-emitting control unit 103 has a first end and a second end, and each light-emitting unit 301 has a first end and a second end. Specifically, the first and second ends of the first light-emitting control unit 102, the first and second ends of the second light-emitting control unit 103 and the first and second ends of the light-emitting unit 301 are all schematically shown in the figures for illustrations. Those skilled in the art can obtain positions of the first and second ends of the first light-emitting control unit 102, the first and second ends of the second light-emitting control unit 103, and the first and second ends of the light-emitting unit 301 according to the connection relationship.

The plurality of first light-emitting control units 102 correspond to the plurality of light-emitting unit groups 201 one-to-one. Namely, in this embodiment of the present application, the number of the first light-emitting control units 102 is equal to the number of the light-emitting unit groups 201. The first end of each first light-emitting control unit 102 is electrically connected to the first voltage line GND. The second end of each first light-emitting control unit 102 is connected to the first end of each light-emitting unit 301 in the corresponding light-emitting unit group 201. The plurality of second light-emitting control units 103 correspond to the plurality of light-emitting units 301 one-to-one. Namely, in this embodiment of the present application, the number of second light-emitting control units 103 is equal to the number of light-emitting units 301 in one light-emitting unit group 201. The first end of each second light-emitting control unit 103 is electrically connected to the second voltage line VLED. The second end of each second light-emitting control unit 103 is electrically connected to the second end of the corresponding light-emitting unit 301.

Specifically, in this embodiment of the present application, the plurality of first light-emitting control units 102 and the plurality of second light-emitting control units 103 perform light-emitting control to the backlight module 10. Furthermore, in this embodiment of the present application, one first light-emitting control unit 102 and the plurality of second control units 103 jointly control the plurality of light-emitting units 301 in one light-emitting unit group 201 to emit light. When the backlight module 10 controls one light-emitting unit 301 in one light-emitting unit group 201 to emit light, the first light-emitting control unit 102 corresponding to the light-emitting unit group 201 can be determined first, and then the second light-emitting control unit 103 corresponding to the light-emitting unit 301 can be determined, thereby jointly controlling the light-emitting unit 301 to emit light by the first light-emitting control unit 102 and the second light-emitting control unit 103. Namely, in this embodiment of the present application, the first light-emitting control unit 102 and the second light-emitting control unit 103 are both employed to control the light-emitting unit 301 to emit light.

Each column of light-emitting units 301 is correspondingly arranged with one column line 104. Namely, the number of the column lines 104 in this embodiment of the present application is equal to the number of columns of the light-emitting units 301 of the backlight module 10. The first end of each light-emitting units 301 in the same column of the light-emitting units 301 is electrically connected to the same column line 104. Each light-emitting unit group 201 is correspondingly arranged with a plurality of column lines 104, and the column line 104 corresponding to the same light-emitting unit group 201 is electrically connected to the second end of the first light-emitting control unit 102 corresponding thereto.

Each row of light-emitting units 301 is correspondingly arranged with a plurality of row lines 105, and the plurality of row lines 105 correspond to the plurality of columns of light-emitting units 101 in the light-emitting unit group 201 one-to-one. Namely, in this embodiment of the present application, the number of row lines 105 corresponding to each row of light-emitting units 301 is equal to the number of columns of light-emitting units 301 in each light-emitting unit group 201. Each light-emitting unit 301 in the light-emitting unit group 201 is correspondingly electrically connected to one row line 105, and each of the row lines 105 is correspondingly electrically connected to the second end of the second light-emitting control unit 103 corresponding thereto. The plurality of light-emitting units 301 in the different light-emitting unit groups 201 correspond one-to-one, and the corresponding light-emitting units 301 in the different light-emitting unit groups 201 are electrically connected to the same row line 105.

Specifically, in this embodiment of the present application, the plurality of row lines 104 corresponding to all the light-emitting unit groups 201 are arranged at intervals along a row direction. The plurality of row lines 105 corresponding to all rows of the light-emitting units 301 are arranged at intervals along a column direction. The interval among the plurality of row lines 104 and the interval among the plurality of row lines 105 can be arranged according to actual conditions.

In some embodiments, the first light-emitting control unit 102 comprises a first switching element S1 and a constant current subunit I. The first switching element S1 is arranged in series with the constant current subunit I. The first switching element S1 may be a switch. The constant current subunit I may be a constant current circuit. Specifically, the first switching element S1 can be other devices with similar switching function, and the constant current subunit I can be other units with similar function to the constant current circuit, which are not limited here. One end of the constant current subunit I is electrically connected to the corresponding column line 104, the other end of the constant current subunit T is electrically connected to one end of the first switching element S1, and the other end of the first switching element S1 is electrically connected to the first voltage line GND.

In some embodiments, the second light-emitting control unit 103 comprises a second switching element S2. The second switching element S2 may be a switch. Specifically, the second switching element S2 can be other devices with similar switching function. One end of the second switching element S2 is electrically connected to the second voltage line VLED, and the other end of the second switching element S2 is electrically connected to the corresponding row line 105.

Specifically, the backlight module 10 comprises a first side A, a first opposite side B, a second side C and a second opposite side D. The first side A is opposite to the first opposite side B, and the second side C is opposite to the second opposite side D. It can be understood that the first side A, the first opposite side B, the second side C and the second opposite side D surround the periphery of the backlight module 10. The plurality of first light-emitting control units 102 and the first voltage line GND are located on the first side A. The plurality of second light-emitting control units 103 and the second voltage line VLED are located on the second side C.

Namely, in the embodiment of the present application, the plurality of first light-emitting control units 102 correspond to the plurality of light-emitting unit groups 201 one-to-one, and the plurality of second light-emitting control units 103 correspond to the plurality of light-emitting units 301 in the light-emitting unit group 201 one-to-one. Therefore, the first light-emitting control unit 102 can be multiplexed, thereby reducing the number of the first light-emitting control units 102. In the embodiment of the present application, the first light-emitting control unit 102 is a column light-emitting control unit, and the second light-emitting control unit 103 is a row light-emitting control unit. The embodiment of the present application can multiplex the column light-emitting control units according to product requirements, so that the number of column light-emitting control units can be reduced.

Please refer to FIG. 2. FIG. 2 is a schematic diagram of a second structure of a backlight module provided by an embodiment of the present application. The difference between the backlight module 20 shown in FIG. 2 and the backlight module 10 shown in FIG. 1 is: the constant current subunit I in the backlight module 10 shown in FIG. 1 is directly connected to the light-emitting array 101; the constant current subunit I in the backlight module 20 shown in FIG. 2 is connected to the light-emitting array 101 through the first switching element S1.

As shown in FIG. 2, one end of the first switching element S1 is electrically connected to the corresponding column line 104, the other end of the first switching element S1 is electrically connected to one end of the constant current sub-unit I, and the other end of the constant current sub-unit I is electrically connected to the first voltage line GND. In this embodiment of the present application, the constant current subunit I is connected to the light-emitting array 101 through the first switching element S1, instead of directly connecting the constant current subunit I to the light-emitting array 101, so that it can prevent the constant current subunit I from affecting the light-emitting array 101.

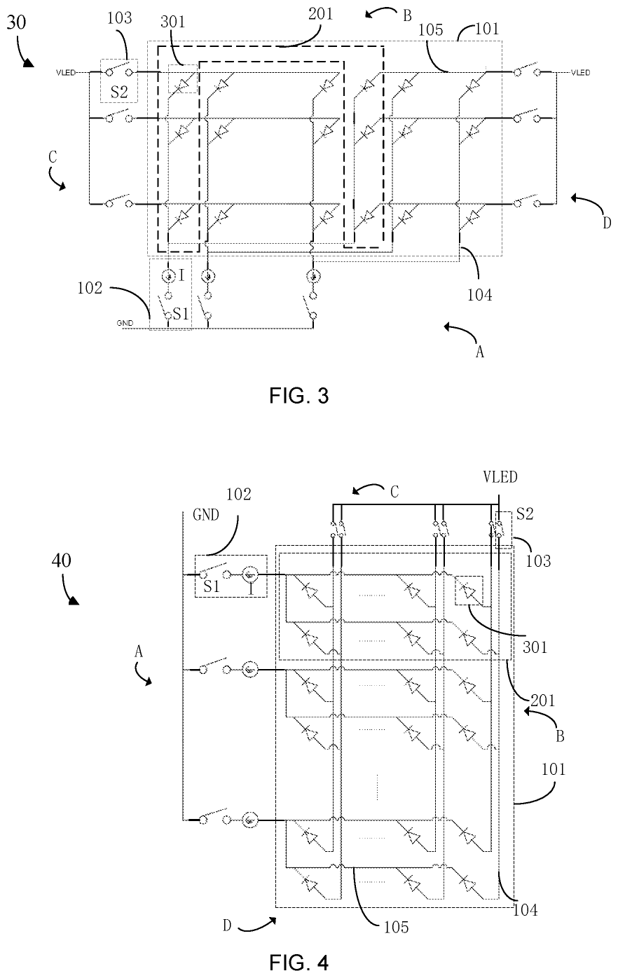

Please refer to FIG. 3. FIG. 3 is a schematic diagram of a third structure of a backlight module provided by an embodiment of the present application. The difference between the backlight module 30 shown in FIG. 3 and the backlight module 10 shown in FIG. 1 is: the backlight module 10 shown in FIG. 1 is arranged with the second light-emitting control unit 103 and the second voltage line VLED on the second side C, and is not arranged with the second light-emitting control unit 103 and the second voltage line VLED on the second opposite side D; the backlight module 30 shown in FIG. 3 is arranged with the second light-emitting control unit 103 and the second voltage line VLED on both the second side C and the second opposite side D.

Specifically, the backlight module further comprises a third side (the second side C) and a fourth side (the second opposite side D) that are arranged oppositely, and the third side and the fourth side are arranged with the second light-emitting control unit 103 and the second voltage line VLED. The plurality of row lines 105 corresponding to all rows of the light-emitting units 301 are arranged at intervals along a row direction. For instance, one row of the light-emitting units 301 corresponds to two row lines 105. These two row lines 105 are arranged at intervals along a row direction.

Namely, in the embodiment of the present application, the plurality of first light-emitting control units 102 correspond to the plurality of light-emitting unit groups 201 one-to-one, and the plurality of second light-emitting control units 103 correspond to the plurality of light-emitting units 301 in the light-emitting unit group 201 one-to-one. Therefore, the first light-emitting control unit 102 can be multiplexed, thereby reducing the number of the first light-emitting control units 102. In the embodiment of the present application, the first light-emitting control unit 102 is a column light-emitting control unit, and the second light-emitting control unit 103 is a row light-emitting control unit. The embodiment of the present application can multiplex the column light-emitting control units according to product requirements, so that the number of column light-emitting control units can be reduced.

Please refer to FIG. 4. FIG. 4 is a schematic diagram of a fourth structure of a backlight module provided by an embodiment of the present application. The difference between the backlight module 40 shown in FIG. 4 and the backlight module 10 shown in FIG. 1 is: the backlight module 10 shown in FIG. 1 multiplexes column light-emitting control units, thereby reducing the number of column light-emitting control units; the backlight module 40 shown in FIG. 4 multiplexes row light-emitting control units, so that the number of row light-emitting control units can be reduced. As shown in FIG. 4, the backlight module 40 provided by the embodiment of the present application comprises a light-emitting array 101, a plurality of first light-emitting control units 102 and a plurality of second light-emitting control units 103. The light-emitting array 101 comprises a plurality of light-emitting unit groups 201. Each of the light-emitting unit groups 201 has a plurality of light-emitting units 301. The plurality of light-emitting units 301 are arranged in an array. Each first light-emitting control unit 102 has a first end and a second end, each second light-emitting control unit 103 has a first end and a second end, and each light-emitting unit 301 has a first end and a second end. Specifically, the first and second ends of the first light-emitting control unit 102, the first and second ends of the second light-emitting control unit 103 and the first and second ends of the light-emitting unit 301 are all schematically shown in the figures for illustrations. Those skilled in the art can obtain positions of the first and second ends of the first light-emitting control unit 102, the first and second ends of the second light-emitting control unit 103, and the first and second ends of the light-emitting unit 301 according to the connection relationship.

The plurality of first light-emitting control units 102 correspond to the plurality of light-emitting unit groups 201 one-to-one. Namely, in this embodiment of the present application, the number of the first light-emitting control units 102 is equal to the number of the light-emitting unit groups 201. The first end of each first light-emitting control unit 102 is electrically connected to the first voltage line GND. The second end of each first light-emitting control unit 102 is connected to the first end of each light-emitting unit 301 in the corresponding light-emitting unit group 201. The plurality of second light-emitting control units 103 correspond to the plurality of light-emitting units 301 one-to-one. Namely, in this embodiment of the present application, the number of second light-emitting control units 103 is equal to the number of light-emitting units 301 in one light-emitting unit group 201. The first end of each second light-emitting control unit 103 is electrically connected to the second voltage line VLED. The second end of each second light-emitting control unit 103 is electrically connected to the second end of the corresponding light-emitting unit 301.

Each row of light-emitting units 301 is correspondingly arranged with one row line 105. Namely, the number of the row lines 105 in this embodiment of the present application is equal to the number of rows of the light-emitting units 301 of the backlight module 10. The first end of each light-emitting unit 301 in the same row of the light-emitting units 301 is electrically connected to the same row line 105. Each light-emitting unit group 201 is correspondingly arranged with a plurality of row lines 105, and the row line 105 corresponding to the same light-emitting unit group 201 is electrically connected to the second end of the first light-emitting control unit 102 corresponding thereto.

Each column of light-emitting units 301 is correspondingly arranged with a plurality of column lines 104, and the plurality of column lines 104 correspond to the plurality of columns of light-emitting units 101 in the light-emitting unit group 201 one-to-one. Namely, in this embodiment of the present application, the number of column lines 104 corresponding to each row of light-emitting units 301 is equal to the number of rows of light-emitting units 301 in each light-emitting unit group 201. Each light-emitting unit 301 in the light-emitting unit group 201 is correspondingly electrically connected to one column line 104, and each of the column lines 104 is correspondingly electrically connected to the second end of the second light-emitting control unit 103 corresponding thereto. The plurality of light-emitting units 301 in the different light-emitting unit groups 201 correspond one-to-one, and the corresponding light-emitting units 301 in the different light-emitting unit groups 201 are electrically connected to the same column line 104.

Specifically, the plurality of row lines 105 corresponding to all the light-emitting unit groups 201 are arranged at intervals along a column direction. The plurality of column lines 104 corresponding to all columns of the light-emitting units 301 are arranged at intervals along a row direction. The interval among the plurality of row lines 104 and the interval among the plurality of row lines 105 can be arranged according to actual conditions.

Specifically, the backlight module 10 comprises a first side A, a first opposite side B, a second side C and a second opposite side D. The first side A is opposite to the first opposite side B, and the second side C is opposite to the second opposite side D. It can be understood that the first side A, the first opposite side B, the second side C and the second opposite side D surround the periphery of the backlight module 10. The plurality of first light-emitting control units 102 and the first voltage line GND are located on the first side A. The plurality of second light-emitting control units 103 and the second voltage line VLED are located on the second side C.

Namely, in the embodiment of the present application, the plurality of first light-emitting control units 102 correspond to the plurality of light-emitting unit groups 201 one-to-one, and the plurality of second light-emitting control units 103 correspond to the plurality of light-emitting units 301 in the light-emitting unit group 201 one-to-one. Therefore, the first light-emitting control unit 102 can be multiplexed, thereby reducing the number of the first light-emitting control units 102. In the embodiment of the present application, the first light-emitting control unit 102 is a row light-emitting control unit, and the second light-emitting control unit 103 is a column light-emitting control unit. The embodiment of the present application can multiplex the row light-emitting control units according to product requirements, so that the number of row light-emitting control units can be reduced.

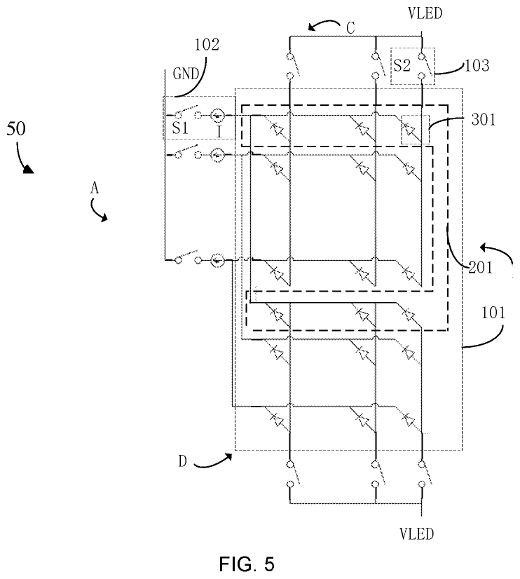

Please refer to FIG. 5. FIG. 5 is a schematic diagram of a fifth structure of a backlight module provided by an embodiment of the present application. The difference between the backlight module 50 shown in FIG. 5 and the backlight module 40 shown in FIG. 4 is: the backlight module 40 shown in FIG. 4 is arranged with the second light-emitting control unit 103 and the second voltage line VLED on the second side C, and is not arranged with the second light-emitting control unit 103 and the second voltage line VLED on the second opposite side D; the backlight module 50 shown in FIG. 5 is arranged with the second light-emitting control unit 103 and the second voltage line VLED on both the second side C and the second opposite side D.

Specifically, the backlight module further comprises a third side (the second side C) and a fourth side (the second opposite side D) that are arranged oppositely, and the third side and the fourth side are arranged with the second light-emitting control unit 103 and the second voltage line VLED. The plurality of column lines 104 corresponding to all columns of the light-emitting units 301 are arranged at intervals along a column direction.

Namely, in the embodiment of the present application, the plurality of first light-emitting control units 102 correspond to the plurality of light-emitting unit groups 201 one-to-one, and the plurality of second light-emitting control units 103 correspond to the plurality of light-emitting units 301 in the light-emitting unit group 201 one-to-one. Therefore, the first light-emitting control unit 102 can be multiplexed, thereby reducing the number of the first light-emitting control units 102.

In the embodiment of the present application, the first light-emitting control unit 102 is a row light-emitting control unit, and the second light-emitting control unit 103 is a column light-emitting control unit. The embodiment of the present application can multiplex the row light-emitting control units according to product requirements, so that the number of row light-emitting control units can be reduced.

The embodiment of the present application further provides a display device, comprising the aforesaid backlight module and a display panel. The display panel is arranged on the backlight module. For details of the backlight module, please refer to the above description, which will not be repeated here.

The backlight module and the display device provided by the embodiments of the present application are described in detail as aforementioned, and the principles and implementations of the present application have been described with reference to specific illustrations. The description of the foregoing embodiments is merely for helping to understand the technical solutions of the present application and the core ideas thereof; meanwhile, those skilled in the art will be able to change the specific embodiments and the scope of the application according to the idea of the present application. In conclusion, the content of the specification should not be construed as limiting the present application.

1. A backlight module, comprising:
a light-emitting array comprising a plurality of light-emitting unit groups, each of the light-emitting unit groups comprises a plurality of light-emitting units, and the plurality of light-emitting units are arranged in an array;
a plurality of first light-emitting control units, and the plurality of first light-emitting control units correspond to the plurality of light-emitting unit groups one-to-one, and a first end of each first light-emitting control unit is electrically connected to a first voltage line, and a second end of each first light-emitting control unit is connected to a first end of each light-emitting unit in the corresponding light-emitting unit group; and
a plurality of second light-emitting control units, and the plurality of second light-emitting control units correspond to the plurality of light-emitting unit groups one-to-one, and a first end of each second light-emitting control unit is electrically connected to a second voltage line, and a second end of each second light-emitting control unit is electrically connected to a second end of the corresponding light-emitting unit.

2. The backlight module according to claim 1, wherein one column of the light-emitting units corresponds to one column line, and the first ends of all the light-emitting units in the same column is electrically connected to the same column line; the column lines corresponding to the same light-emitting unit group are electrically connected to the second end of the first light-emitting control unit corresponding thereto.

3. The backlight module according to claim 2, wherein the backlight module comprises a first side, and the plurality of first light-emitting control units and the first voltage line are located on the first side.

4. The backlight module according to claim 1, wherein the first light-emitting control unit comprises a first switching element and a constant current subunit, and the first switching element is arranged in series with the constant current subunit.

5. The backlight module according to claim 1, wherein one row of the light-emitting units corresponds to a plurality of row lines, and the plurality of row lines corresponds to the plurality of columns of the light-emitting units in the light-emitting unit group one-to-one; each light-emitting unit in the light-emitting unit group is correspondingly electrically connected to one of the row lines, and each of the row lines is correspondingly electrically connected to the second end of the corresponding second light-emitting control unit.

6. The backlight module according to claim 5, wherein the light-emitting units in the different light-emitting unit groups correspond one-to-one, and the corresponding light-emitting units in the different light-emitting unit groups are electrically connected to the same row line.

7. The backlight module according to claim 6, wherein the backlight module comprises a second side, and the plurality of second light-emitting control units and the second voltage line are located on the second side.

8. The backlight module according to claim 6, wherein the backlight module further comprises a third side and a fourth side which are arranged oppositely, and the third side and the fourth side are arranged with the second light-emitting control unit and the second voltage line.

9. The backlight module according to claim 7, wherein the plurality of row lines corresponding to each row of the light-emitting units are arranged at intervals along a column direction.

10. The backlight module according to claim 8, wherein the plurality of row lines corresponding to each row of the light-emitting units are arranged at intervals along a row direction.

11. The backlight module according to claim 1, wherein one row of the light-emitting units corresponds to one row line, and the first ends of all the light-emitting units in the same row are electrically connected to the same row line; the row lines corresponding to the same light-emitting unit group are electrically connected to the second end of the corresponding first light-emitting control unit.

12. The backlight module according to claim 1, wherein one column of the light-emitting units corresponds to a plurality of column lines, and the plurality of column lines corresponds to the plurality of rows of the light-emitting units in the light-emitting unit group one-to-one; each of the light-emitting units in the light-emitting unit group is correspondingly electrically connected to one of the column lines, and each of the column lines is correspondingly electrically connected to the second end of the second light-emitting control unit corresponding thereto.

13. The backlight module according to claim 12, wherein the light-emitting units in the different light-emitting unit groups correspond one-to-one, and the corresponding light-emitting units in the different light-emitting unit groups are electrically connected to the same column line.

14. The backlight module according to claim 13, wherein the plurality of column lines corresponding to each column of the light-emitting units are arranged at intervals along a column direction.

15. The backlight module according to claim 13, wherein the plurality of column lines corresponding to each column of the light-emitting units are arranged at intervals along a row direction.

16. A display device, comprising a backlight module and a display panel, and the display panel is arranged on the backlight module;
the backlight module comprises:
a light-emitting array comprising a plurality of light-emitting unit groups, each of the light-emitting unit groups comprises a plurality of light-emitting units, and the plurality of light-emitting units are arranged in an array;
a plurality of first light-emitting control units, and the plurality of first light-emitting control units correspond to the plurality of light-emitting unit groups one-to-one, and a first end of each first light-emitting control unit is electrically connected to a first voltage line, and a second end of each first light-emitting control unit is connected to a first end of each light-emitting unit in the corresponding light-emitting unit group; and
a plurality of second light-emitting control units, and the plurality of second light-emitting control units correspond to the plurality of light-emitting unit groups one-to-one, and a first end of each second light-emitting control unit is electrically connected to a second voltage line, and a second end of each second light-emitting control unit is electrically connected to a second end of the corresponding light-emitting unit.

17. The display device according to claim 16, wherein one column of the light-emitting units corresponds to one column line, and the first ends of all the light-emitting units in the same column is electrically connected to the same column line; the column lines corresponding to the same light-emitting unit group are electrically connected to the second end of the first light-emitting control unit corresponding thereto.

18. The display device according to claim 17, wherein the backlight module comprises a first side, and the plurality of first light-emitting control units and the first voltage line are located on the first side.

19. The display device according to claim 16, wherein the first light-emitting control unit comprises a first switching element and a constant current subunit, and the first switching element is arranged in series with the constant current subunit.

20. The display device according to claim 16, wherein one row of the light-emitting units corresponds to a plurality of row lines, and the plurality of row lines corresponds to the plurality of columns of the light-emitting units in the light-emitting unit group one-to-one; each light-emitting unit in the light-emitting unit group is correspondingly electrically connected to one of the row lines, and each of the row lines is correspondingly electrically connected to the second end of the corresponding second light-emitting control unit.
